(19) United States
(12) Patent Application Publication
(10) Pub. No.: US 2012/0139755 A1
(43) Pub. Date: Jun. 7, 2012

(54) Automatic Detection of Road Conditions

(75) Inventor: Matthew L. Ginsberg, Eugene, OR (US)

(73) Assignee: ON TIME SYSTEMS, INC., Eugene, OR (US)

(21) Appl. No.: 13/372,391

(22) Filed: Feb. 13, 2012

Related U.S. Application Data
(63) Continuation-in-part of application No. 12/639,770, filed on Dec. 16, 2009.
(60) Provisional application No. 61/233,123, filed on Aug. 11, 2009.

(51) Int. Cl. G08G 1/0967

(52) U.S. Cl. 340/905

(57) ABSTRACT

A system for automatic detection of road conditions reduces emissions from vehicles by determining whether proposed routes may be less efficient due to weather conditions. In one aspect, the system chooses routes not only based on overall distance to travel, but also based weather conditions. The determination is made by information received from various sources, including other vehicles and roadside sensors. In-vehicle warnings are also provided by combining data from in-vehicle sensors with data from other sources, such as conditions currently sensed at upcoming locations and historical and forecast weather data.

### RELATED APPLICATION

This application is a continuation in part of U.S. patent application Ser. No. 12/639,770 filed Dec. 16, 2009, which is related to U.S. Provisional Patent Application No. 61/233,123 filed Aug. 11, 2009, and claims priority therefrom pursuant to 35 U.S.C. §120. These applications are hereby included in full by reference as part of the present application.

### FIELD OF INVENTION

The present invention relates generally to increasing vehicle efficiency thereby reducing emission of carbon and other pollutants as well as increasing safety and reducing fuel costs, and specifically to methods and systems for using known weather data to route vehicles away from areas with weather problems that might lead to longer travel times, traffic jams, and unsafe driving environments.

### BACKGROUND

In many vehicle journeys, whether commercial long-haul trucking or automobile vacation travel, the speed, cost and safety of a trip are impacted by the weather encountered en route.

When trip planning was performed manually, savvy motorists would consider such factors in selecting their routes. For instance, trans-continental drivers might avoid mountain passes in the winter and avoid hot desert stretches in the summer. Weather-related considerations included travel time, overall distance traveled, fuel usage (which increases not only with longer routes but with weather-related traffic jams), and safety.

With the growing popularity of GPS and hand-held computing devices, particularly those connected to cellular networks or the internet, a large amount of data about weather en route is available to a vehicle's navigational and control systems. For years, vehicles have been equipped with “ice warning” sensors that illuminate when the ambient temperature drops to a few degrees above freezing. While somewhat helpful, such systems often illuminate unnecessarily, for instance where a route is not expected to include any areas that will actually have freezing temperatures, or where freezing temperatures are encountered in areas that have not had precipitation for days. The false positives that result naturally dull a driver's attention to these warning devices.

In still another related area, local sensors on a vehicle have little capacity to predict future weather that is likely to be encountered on any particular route. Thus, drivers may decide to continue on a late night journey when a better decision would be to wait until the morning, or they may decide to stop for the night when a better decision might have been to continue driving for a few more hours to avoid upcoming weather in a particularly dangerous location (e.g., a mountain pass).

Still further, a particular choice of a route of travel may be sensible in one type of weather but not in another, and it would be helpful for drivers to be able to use routes most appropriate for the anticipated weather conditions between their origin and destination locations.

No known approaches fully integrate the technologies that are available to report weather-related information to vehicles and utilize that information to choose most efficient and safe routes and times of travel.

### SUMMARY

A computer-implemented method and a corresponding system use weather information from a remote facility (e.g., an Internet-accessible weather site) to automatically suggest routes of travel from an origin to a destination, to warn of upcoming icy, snowy or windy road conditions, to suggest times that drivers should continue or suspend their travel, and to activate safety warnings within vehicles.

In one aspect, the method and system use one or more of historical weather data, forecast weather data, data regarding other vehicles obtained from the other vehicles, data regarding roadway clearing operations and data from roadside sensors.

In another aspect, the method and system activate an indicator responsive to both data from a remote facility and data from an on-board sensor.

### BRIEF DESCRIPTION OF THE DRAWINGS

FIG. 1 is a high-level block diagram of the computing environment in accordance with an embodiment of the invention.

FIG. 2 is a block diagram of a user device, in accordance with an embodiment of the invention.

FIG. 3 is a block diagram of a weather facility, in accordance with an embodiment of the invention.

FIG. 4 is a block diagram of a controller, in accordance with an embodiment of the invention.

FIG. 5 is a block diagram of a vehicle equipped with a vehicle management system, in accordance with an embodiment of the invention.

FIG. 6 is a block diagram illustrating an example of a computer for use as a user device, a weather facility, or a controller, in accordance with an embodiment of the invention.

FIG. 7 is a flow chart illustrating a method of determining routing responsive to weather information from a weather facility.

FIG. 8 is a flow chart illustrating a method of determining whether to activate a vehicle warning responsive to weather information from a weather facility.

One skilled in the art will readily recognize from the following discussion that alternative embodiments of the structures and methods illustrated herein may be employed without departing from the principles of the invention set forth in the claims.

### DETAILED DESCRIPTION OF THE EMBODIMENTS

Embodiments of the present invention provide systems and methods that use location-based technologies such as GPS or cellular to provide improved safety information and efficient routing. Embodiments include one-way or two-way communication between weather facilities and drivers, and communication with routing facilities. Vehicles are equipped with user devices that report their location to a weather facility and optionally also report the driver's destination to the weather facility and a routing facility. The facilities send information to the user devices such as whether icing conditions actually are likely and suggestions for the driver's travel (e.g., alternate routing due to weather and upcoming weather that may impact the driver's plans for the journey).

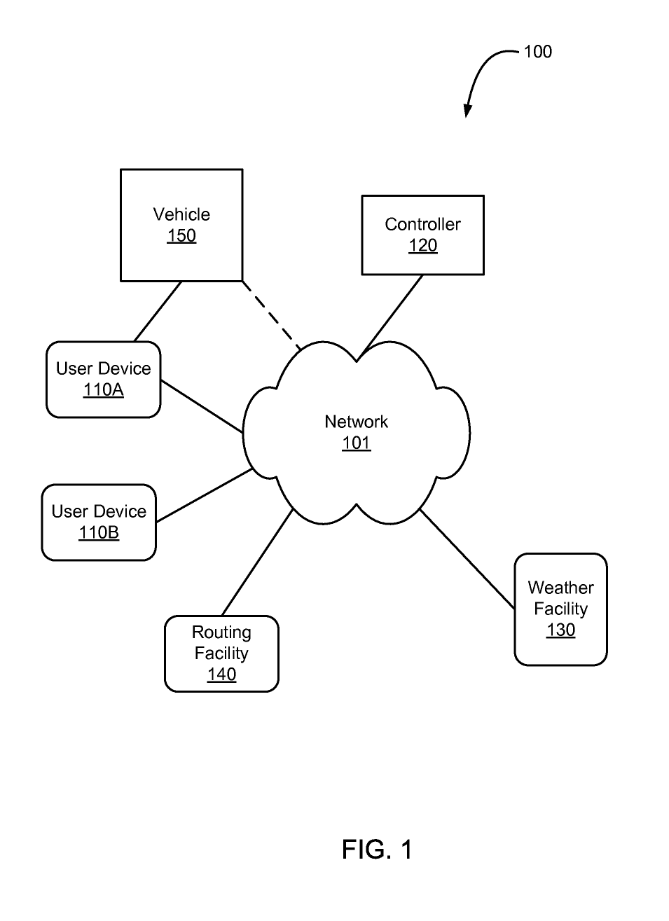

FIG. 1 is an illustration of a system 100 in accordance with one embodiment of the invention. The system 100 includes a plurality of user devices e.g. 110A and 110B, that are coupled to a network 101. In various embodiments, user devices 110 may include a computer terminal, a personal digital assistant (PDA), a wireless telephone or smartphone, an on-vehicle computer permanently installed in and integrated with the other electronic systems of the vehicle (e.g, navigation system, external temperature display, and automatic braking system or ABS), or various other user devices capable of connecting to the network 101. In various embodiments, the communications network 101 is a local area network (LAN), a wide area network (WAN), a wireless network, an intranet, or the Internet, for example. In one specific embodiment, user device 110 is an iPhone® device provided by Apple, Inc. and programmed with a user-downloadable application providing one or more of the functions described herein.

The system 100 also includes a weather facility 130 that is connected to the network 101 and a routing facility 140. Presently, a number of publicly accessible commercial and governmental weather facilities are available over the Internet, in addition to private facilities available on a subscription basis. For example, the National Oceanic and Atmospheric Administration maintains several weather facilities at www.noaa.gov that provide location-specific weather condition and forecast information. Some such sites allow location-based queries that return various types of weather condition and forecast information in machine-usable formats.

In one embodiment, routing facility 140 calculates one or more proposed routes for a user's vehicle based on a desired destination and is connected to the user device via the Internet; in other embodiments routing facility is implemented locally (e.g., as an application running locally on a user device 110). In one implementation, a controller 120 controls operation of a variety of roadway-related intelligent/connected devices (e.g., traffic signals, metering lights, roadway warning signs, street lights), at least some of which are equipped with sensors for weather related information such as temperature sensors, precipitation sensors and wind sensors.

A single vehicle 150 is illustrated. It is envisaged that many vehicles may be part of system 100; the single vehicle 150 is included to be illustrative of how these vehicles interact with the other components of the system 100 and should not be taken to indicate any limitation on the total number of vehicles that may be included. In one embodiment a user device 110A is physically located inside the vehicle 150 and communicatively connected to it. This connection may be wired, such as a LAN or direct USB connection, wireless, such as a Bluetooth® connection, or any other method by which data can be transferred between the user device 110A and the vehicle 150. Optionally, the vehicle 150 can connect directly to the network 101. This connection can either supplement the connection with the user device 110A, or be the means by which that connection is enabled.

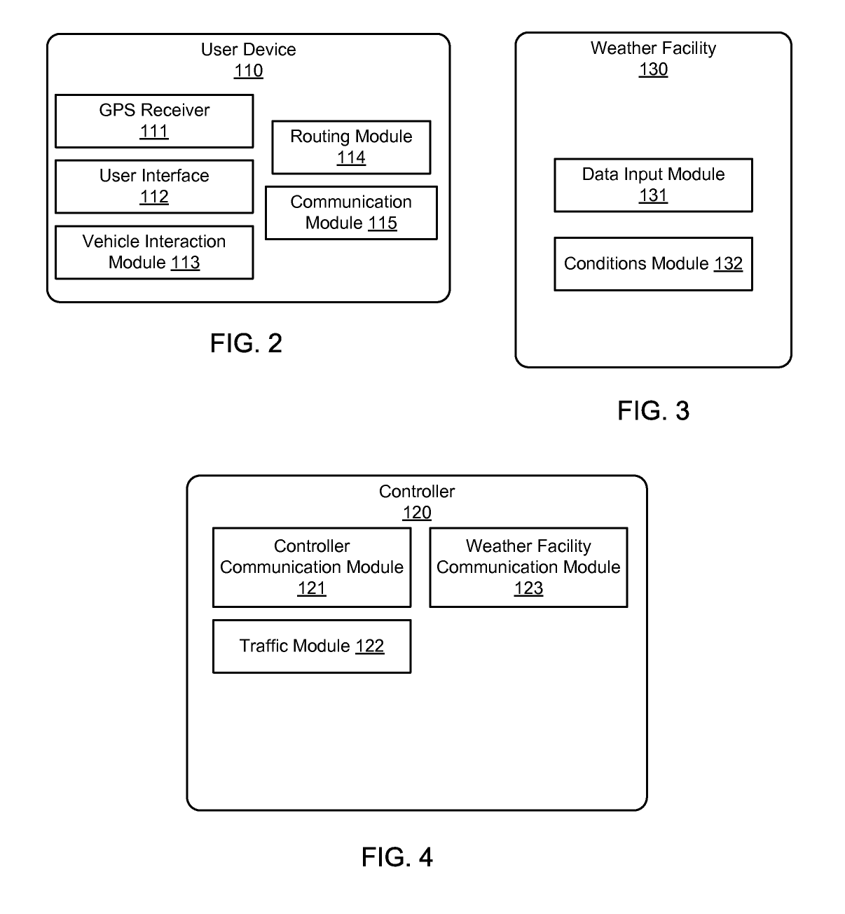

FIG. 2 is a block diagram of a user device 110, in accordance with an embodiment of the invention. The user device 110 is in the vehicle 150 with the driver when in operation in the system 100. The user device 110 includes a GPS receiver 111, a user interface 112, a vehicle interaction module 113, a routing module 114 and a communication module 115.

The GPS receiver 111 of the user device 110 functions to identify a precise location of the user device 110 from GPS satellite system signals received at the user device 110. Suitable GPS receivers are commonly found in handheld computing devices such as cell phones, on-board navigation systems, and other electronics. The GPS receiver 111 determines the location of the user device 110 for communication to controller 120, weather facility 130, and routing facility 140 as may be appropriate per the discussion herein. In one embodiment routing facility 140 is a large processing facility capable of handling thousands of routing requests from user devices (e.g., 110A) simultaneously, such as is provided on the “get directions” feature of the Google Maps web service. In other embodiments, the routing functionalities discussed herein can be distributed between such large facilities and processors of user devices themselves (e.g., 110A).

As an alternative to GPS, cellular signals or other known location-determining technologies may be used to determine the position of the user device 110. For clarity, the location is discussed herein as having been determined from GPS signals although Wi-Fi hot spot detection, cellular signals or other technologies as are well known for determining location can be used in alternate embodiments.

The user interface 112 of the user device 110 allows the user to input information into the user device 110 and displays information to the user. For example, the user may input a desired destination into the user interface 112 of the user device 110. The user interface 112 may display directions or a route to travel to arrive at the desired destination. The user interface 112 may also display other information relevant to the driver derived from the GPS signals received by the GPS receiver 111, received from the weather facility 130, or from other sources, such as outdoor ambient temperature as sensed by on-board temperature sensors of vehicle 150.

The vehicle interaction module 113 of the user device 110 manages the communication between the user device 110 and vehicle 150. For example, on-board sensors of vehicle 150 are in some embodiments made available for use by user device 110 via a Bluetooth communication facility managed by vehicle interaction module 113. Currently, a number of late model vehicles support Bluetooth communications for functions such as hands free cellphone usage, access to music libraries and the like; thus, access to on-board sensors such as external temperature sensors, vehicle braking sensors, vehicle GPS sensors and the like are readily achievable in a similar manner, as is evident to those skilled in the art.

Routing module 114 represents in one embodiment a facility to address part or all of the routing features described in connection with routing facility 140 as may be implemented on user device 110. In some embodiments, for instance where communications channels may not be reliable due to poor radio coverage, certain aspects of the functions described in connection with routing facility 140 may be performed in locally via routing module 114. Typically, complex routing processing using frequently updated information from various sources will most effectively be performed externally (e.g., via routing facility 140), but routing module 114 provides an alternative in environments where local processing of at least some routing-related information is advantageous.

Communication module 115 represents the hardware and software of user device 110 used to communicate with the outside world, for instance via network 101. Such functionality is already standard in commercially available smartphones for providing Internet connectivity and the like. As one example of specific usage as described herein, communication module 115 sends the location information determined by the GPS receiver 111 to the routing facility 140 and receives, for example, information from a nearby controller 120 regarding conditions at the controller.

FIG. 3 is a block diagram of a weather facility 130, in accordance with an embodiment of the invention. The weather facility 130 includes a data input module 131 and a conditions module 132.

The data module 131 processes incoming data from a user device (e.g., 110A) regarding location and sensed local conditions. For example, a vehicle equipped with a user device as described herein reports both its location and the external temperature as determined by its on-board temperature sensor. Other sources of weather information provide temperature, dewpoint, visibility (e.g., fog) and other environmental information in various embodiments to data module 131 as well. To provide just one example, many roadways are equipped with cameras, whether for monitoring traffic congestion or for detecting when vehicles have illegally entered an intersection under a traffic light that has turned red. Pixel-by-pixel analysis of the images from such cameras are readily usable to determine current visibility at that camera's location. Sharp and distinct images with good contrast suggest clear conditions, while lower contrast and fewer sharp transitions from light to dark suggest poor visibility.

The conditions module 132 of the weather facility 130 provides current and in some embodiments forecast weather conditions for any desired location. Where data sources to data input module are numerous, such conditions may be provided directly, while interpolation, extrapolation or other known techniques are used where the available data are relatively sparse. Known weather forecasting techniques are in some embodiments employed to predict not only current conditions at a specified location, but conditions in the future, for instance at a time when a vehicle is expected to arrive at a particular location. As one example, a vehicle leaving a city may either choose a shorter route over a mountain pass three hours' drive away or choose a longer route around the mountain entirely. By determining forecast conditions three hours after the vehicle departs the city, conditions module 132 can report the likely road conditions to routing facility 140 so that this information is used to help determine whether the mountain pass route is preferable to the route around the mountain.

FIG. 4 is a block diagram of a controller 120, in accordance with an embodiment of the invention. The controller includes a controller communication module 121, a traffic module 122, and a weather facility communication module 123. Controller 120 is configurable to manage various roadside facilities, such as traffic lights and roadside warning signals (e.g., “Chains Required on Route 80 at Donner Pass”).

Controller communication module 121 facilitates remote operation of controller 120, for instance by a state department of transportation (DOT) official as weather conditions deteriorate. In some embodiments, such communication is one-way only (e.g., provision of text for an electronic sign by the DOT official); in other embodiments, two-way communication provides, for instance, local conditions information such as a webcam feed back to the DOT official to help the official determine whether conditions warrant some particular message on the sign. Using again the example of mountain weather, such weather is known to vary dramatically over short geographic distances. A weather station at a mountaintop may indicate a dangerous snow squall while the conditions at a nearby mountain pass, where a highway is located, may not be nearly so bad. Thus, such communications from the controller 120 to a DOT official allows more accurate determination of actual roadway conditions than simple reference to weather data might.

In addition, controller 122 includes a traffic module, which in various embodiments provides further input regarding current conditions. In one exemplary embodiment, a webcam aimed at lanes of traffic provides video images that are analyzed to determine whether vehicles are traveling in straight lines as opposed to swerving due to deteriorating conditions. Many mountain pass trouble spots have areas that are particularly treacherous, and merely analyzing video images of moving vehicles can readily be used to detect that traction is being lost.

Weather facility communication module 123 is shown separately in FIG. 4 although in other embodiments it may be integrated with controller communication module 121. Weather facility communication module 123 sends whatever weather-related information may be available at controller 120 (e.g., temperature, dew point, wind speed) to weather facility 130 via network 101. This information can be used to forecast weather at the location of controller 120 and can also be provided, either directly or via weather facility 130, to user devices 110A and 110B.

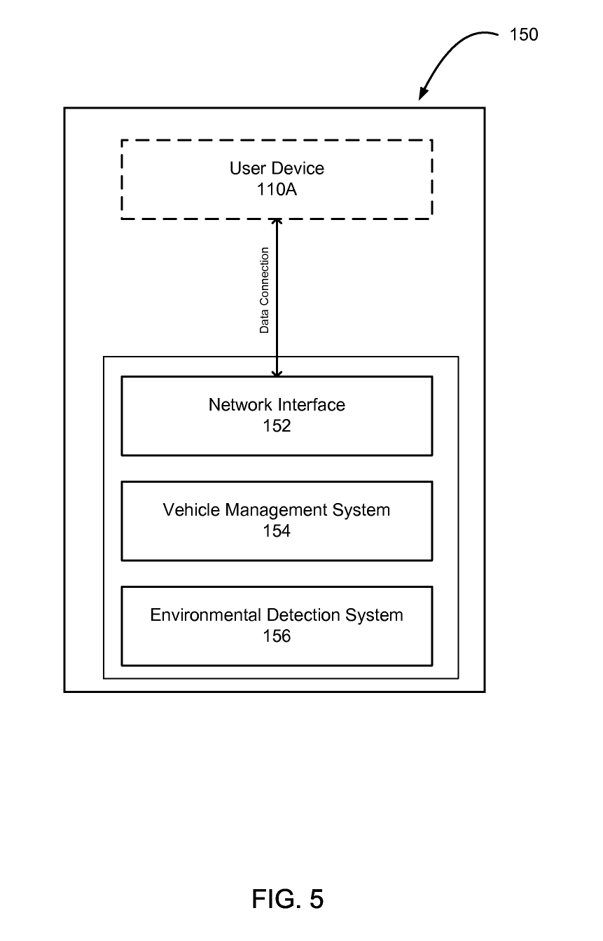

FIG. 5 is a block diagram of a vehicle 150, equipped with a user device 110A, in accordance with an embodiment of the invention. As shown, a user device 110A is physically inside the vehicle 150, but is not itself part of it. The user device 110A is communicatively connected to the vehicle's on-board systems via a network interface 152. The vehicle 150 also includes a vehicle management system 154 that monitors and controls various components the vehicle 150. For instance, vehicle management system 154 includes in a typical embodiment an automated braking system that is used not only for enhanced safety but also for traction control, monitoring of individual wheels speeds for diagnostic purposes (e.g, for automated monitoring of tire pressures) and the like. The vehicle 150 may also include an environmental detection system 156 which includes sensors that gather information about the vehicle's environment, such as outside temperature and presence of mist or rainfall (e.g., for automatic windshield wiper systems).

In one embodiment, vehicle 150 acts as a roaming sensor for weather facility 130; in other embodiments vehicle 150 further acts as a roaming sensor for facilities with which controller 120 may communicate (e.g., a DOT highway conditions office). For example, should vehicle management system 154 indicate repeated slippage of individual tires of the vehicle, vehicle management system 154 reports this condition (indicating a slippery road) to weather facility 130 via network interface 152, user device 110A and network 101. Likewise, severity of rainfall via a mist/rain sensor (or even any rainfall as indicated by the windshield wipers of vehicle 150 being operated for a significant period of time); temperature reading and trend; visibility (for instance as indicated by running lights or fog lights being activated during daylight hours) and the like all provide data points that are usable by weather facility 130 to determine local conditions and forecasts for specific portions of roadways.

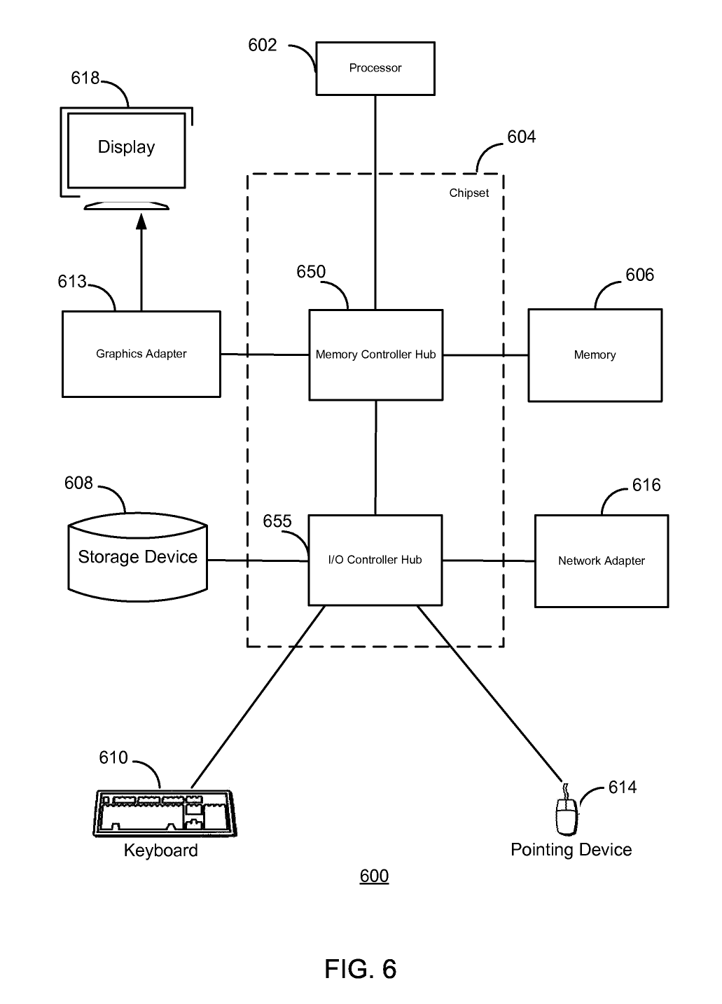

FIG. 6 is high-level block diagram illustrating an example of a computer 600 for use as (or as part of) a user device 110, a controller 120, a weather facility 130 or a routing facility 140, in accordance with an embodiment of the invention. Illustrated are at least one processor 602 coupled to a chipset 604. The chipset 604 includes a memory controller hub 650 and an input/output (I/O) controller hub 655. A memory 606 and a graphics adapter 613 are coupled to the memory controller hub 650, and a display device 618 is coupled to the graphics adapter 613. A storage device 608, keyboard 610, pointing device 614, and network adapter 616 are coupled to the I/O controller hub 655. Other embodiments of the computer 600 have different architectures. For example, the memory 606 is directly coupled to the processor 602 in some embodiments.

The storage device 608 is a computer-readable storage medium such as a hard drive, compact disk read-only memory (CD-ROM), DVD, or a solid-state memory device. The memory 606 holds instructions and data used by the processor 602. The pointing device 614 is a mouse, track ball, or other type of pointing device, and in some embodiments is used in combination with the keyboard 610 to input data into the computer system 600. The graphics adapter 613 displays images and other information on the display device 618. In some embodiments, the display device 618 includes a touch screen capability for receiving user input and selections. The network adapter 616 couples the computer system 600 to the network 101. Some embodiments of the computer 600 have different and/or other components than those shown in FIG. 6.

The computer 600 is adapted to execute computer program modules for providing functionality described herein. As used herein, the term “module” refers to computer program instructions and other logic used to provide the specified functionality. Thus, a module can be implemented in hardware, firmware, and/or software. In one embodiment, program modules formed of executable computer program instructions are stored on the storage device 608, loaded into the memory 606, and executed by the processor 602.

The types of computers 600 used by the entities of FIG. 1 can vary depending upon the embodiment and the processing power used by the entity. For example, a user device 110 that is a PDA typically has limited processing power, a small display 618, and might lack a pointing device 614. The routing facility 140, in contrast, may comprise multiple blade servers working together to provide the functionality described herein.

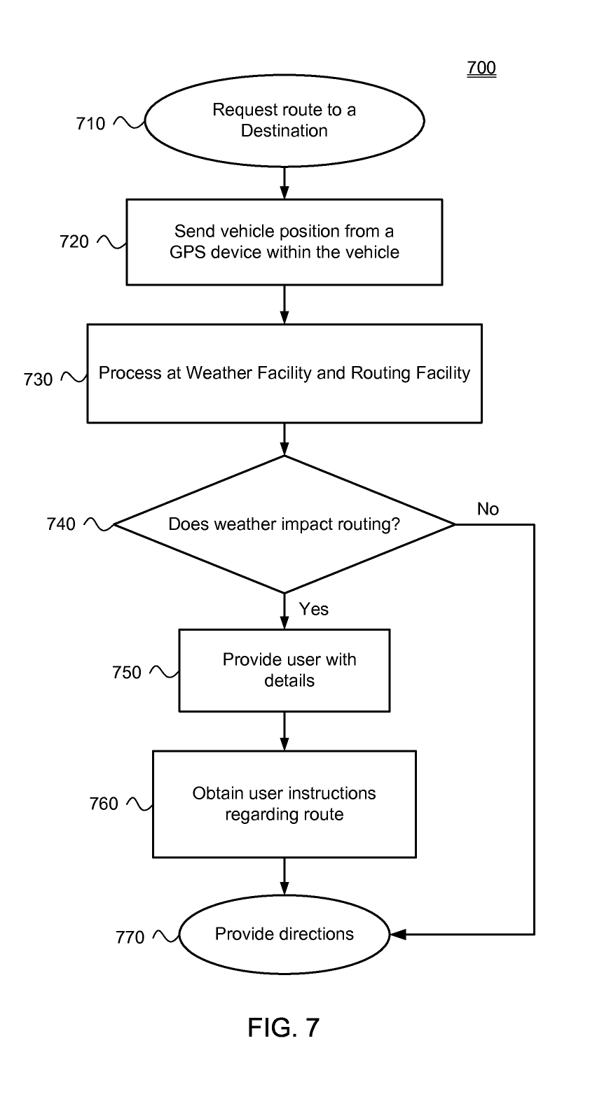

FIG. 7 is a flow chart illustrating a method of providing directions based on weather information. At 710, the vehicle 150, which includes the GPS capable user device 110A, requests a route to a specified destination. For instance, the driver of vehicle 150 employs a user interface to indicate that a route to a particular city from the current location is desired. At 720, current location of the vehicle 150 is sent to routing facility 140 from the user device 110A. The current location may be ascertained using GPS or other signals by the user device 110A and communicated to the routing facility 140 via the network 101. Routing facility 140 communicates information about current location, destination and proposed routes to weather facility 130 via network 101. In other embodiments, the current location information is sent directly from user device 110A to weather facility 130.

At 730, the information about the current location, destination and proposed routing is processed by weather facility 130 and routing facility 140. In one embodiment, routing facility 140 provisionally proposes one or more routings and sends that information for weather facility 130 for processing. In another embodiment, weather facility 130 works independently of routing facility 140 to determine presence of any weather-related issues between the current location and destination, and communicates those issues to routing facility 140. In some embodiments, routing facility 140 and weather facility 130 are implemented as a single integrated facility.

At 740, weather facility 130 and routing facility 140 have processed the available information sufficiently to determine if weather is likely to impact any proposed routes to be presented to the user. If so, at 750 the user is provided with details (e.g., a message proposing two possible routes, explaining that the first is shorter but is likely to include a few icy stretches while the other is longer but is expected to be entirely at above-freezing temperatures). At 760, routing facility 140 receives the users instructions in response to the weather-related message (e.g., selection of a user interface button reading, “I don't mind a few icy stretches”) and at 770 the routing facility provides routing directions accordingly. If there are no weather-related issues, processing moves directly from 740 to 770.

In an alternate embodiment, routing facility 140 automatically makes certain weather-related decisions for the user. For instance, rather than provide the user with details about weather and prompting a user decision, the routing facility may simply choose the most appropriate route, optionally providing an explanatory method if that route differs from the route that would be preferred in good weather. In such an embodiment, a user is given a message such as, “You are being given a route that avoids mountain passes, because snow is expected later today at higher elevations.” A particular advantage of such a system is that motorists may actually be directed to routes that might seem dangerous based on current conditions. For example, in appropriate circumstances a mountain pass road might be selected even though there is still heavy snow there now, with a message reading, “We are routing you on the shortest path, which includes mountain passes. Even though it is currently snowing heavily in the passes, the snow is expected to stop shortly and the roads should be clear by the time you arrive.”

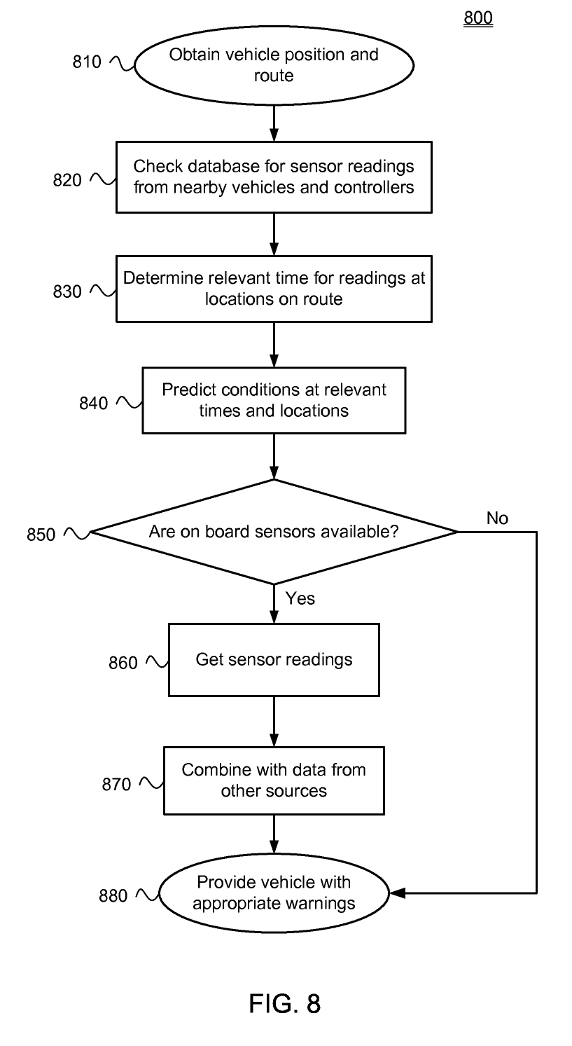

FIG. 8 is a flow chart illustrating a method of determining whether to provide a vehicle's driver with warnings based on the vehicle's location/routing and the weather that is expected en route. Conventional on-board vehicle systems operate without a great deal of context, and thus simply provide a snow flake icon or other indication that roads may become icy as soon as the vehicle's sensor indicates that temperatures have dropped to within a few degrees of freezing (37 degrees Fahrenheit is a common threshold). Such warnings may occur far too frequently to actually indicate potential icing, and so such warnings may eventually be ignored by drivers.

In one embodiment, at 810 a weather facility 130 or routing facility 140 (or a facility integrating the functions of each) obtains the position of a vehicle and, in some embodiments its proposed route. Such information is transmitted from user device 110A to the corresponding facility.

At 820, a check is made of a database (in one embodiment provided by weather facility 130) to determine if any specific weather information is available for the locations of interest. Such information can include temperature, precipitation, visibility, wind and other meteorological readings and is provided from any available source, including conventional fixed weather stations, controllers 120 as discussed above, or other suitably equipped vehicles, also as discussed above. At 830, for each location of interest a determination is made as to the time that such information is required. For locations close to the user's current location, existing sensor readings can be used directly. For other locations, routing information (and optionally the user's current speed and direction from a GPS subsystem of user device 110A) is used to determine a time at which the user will likely be at that location. At 840, a forecast is made as to the weather/roadway conditions at such time. Historical data is used in addition to forecasting techniques in some embodiments to predict conditions. For example, current data and forecast data may indicate that rain is likely with slightly rising temperatures at the time a vehicle is predicted to arrive at a particular location. If the temperatures over the past two days have been generally above freezing, this may indicate that the roadway is not likely to be icy, while if the past couple of days have been extremely cold (i.e., well below freezing), there could be significant icing on the roadway.

At 850, a determination is made as to whether on-board sensors are also available on vehicle 150. If not, information from such sensors is not available for further refined processing, and so the vehicle 150 is provided with the appropriate warning (e.g., illumination of a snowflake icon or, if available, a more helpful text message). If, on the other hand, one or more sensors are available, readings from them are obtained 860 and additional processing is done to combine 870 this information with data from other sources. Using the example above, if historical temperatures have been below freezing, an icing light may be activated when the vehicle's sensor indicates an exterior temperature below 37 degrees, but if historical temperatures have been above freezing, the light may only be activated when the vehicle's sensor indicates an exterior temperature below 33 degrees. In still a further embodiment, a DOT facility may automatically log which road segments have been salted and when, and the icing indicator may be triggered at different thresholds based on this data as well (lower temperature threshold for more recent salt application).

Embodiments of the present invention that provide systems and methods that use location-based technologies such as GPS to provide improved routing and safety based on weather and roadway information have been described above. Benefits of embodiments of the invention include:
1. Reduced fuel consumption. By selecting longer routes only when weather demands them to be used, fuel consumption can be drastically reduced. As well as being financially beneficial to the vehicle owner and reducing goods transport costs, this also significantly reduces emissions of green house gases and other pollutants.
2. Improved safety. In some aspects of the invention described, the system may be used to make it less likely that vehicles will be routed to treacherous portions of roadways.
3. Improved monitoring for municipalities. The results of accurate vehicle environment monitoring can be used in many applications, such as to deploy snow plows and road salting equipment.
4. Accurate real-time planning information. Accurate weather information is useful for trip planning and commuting. The real-time weather and roadway conditions are usable as inputs into various other scheduling systems to ensure timely arrivals for meetings, events, etc. For example, based on the roadway conditions for any given day, an alarm clock may be programmed to wake a person up 30 minutes before he needs to leave for work in order to arrive on time.

The discussion above addresses a system in which there is two-way communication among vehicles and traffic systems. In other embodiments, even simpler one-way communications are used. Specifically, a location-aware user device 110A such as a smart phone in a vehicle sends a message to a weather facility 130 indicating that temperatures are below freezing, that its windshield wipers are on, and that the vehicle's ABS is engaging sufficiently frequently to suggest slippery roadway surfaces. As a specific example, consider a smart phone such as the iPhone® device provided by Apple, Inc. and mentioned above. Such device is location-aware and is readily programmed by software applications to perform a variety of functions. In one specific embodiment, a software application directs the device to periodically send its location and optionally the vehicle's environmental and operational parameters to a specified site via the Internet, for example weather facility 130. Depending on the vehicle's location and heading, weather facility 130 can then communicate with an appropriate DOT office to ensure that proper plowing/salting equipment is deployed or to send proper messages for display on electronic signs (e.g., “Snowy unplowed roads ahead—consider alternate routes).

One-way communication in the other direction is also advantageous in certain embodiments. For example, when a weather facility 130 issues a tornado warning for a particular county, in one embodiment that information is transmitted to user device 110A and if the routing for the user's vehicle includes that county, a warning is displayed.

In one specific embodiment, users are provided incentives to keep their devices in active operation while enroute, rather than just at the outset of a journey. This is advantageous to all users of the system because the more users who are “live” on the system (e.g., have the appropriate application operating on their user devices 110), the more information can be collected from such users regarding weather at various locations. Using the example of an iPhone, for instance, if an “app” implementing the system is kept on during transit, not only will the user obtain updated information, but the system will obtain ongoing weather information from that user.

In order to provide such incentive, a user interface of the application running on user devices 110 provides updated information during travel. In one particular embodiment, the predicted weather for locations that the user is approaching is presented to the user differently depending on the certainty of the prediction. For example, a visual display of the predicted weather can start out, when the prediction is relatively uncertain, as a rather faded color, and increase in intensity as the certainty grows. As another example, a change in predicted weather can be announced to the user by audio as well as visual messaging, and the proposed route can likewise be altered on the fly if an originally preferred route now appears suboptimal due to changes in the predicted weather.

The embodiments discussed herein relate to travel over roadways, but those skilled in the art will readily recognize that other types of travel can also enjoy the benefits of systems and methods as described herein. Thus, trans-oceanic shipping lanes, airplane flight paths, snowmobile routes, and any other mode of travel can have such systems and methods adapted to provide the advantages described herein. Accordingly, terms such as “vehicle” and “road” or “roadway” should be broadly construed herein to refer to any manner of transport over any route. As a specific example, those skilled in the art will recognize that reference to a term such as “roadside sensor” in a marine application would include a sensor mounted on a buoy.

More generally, the present invention has been described in particular detail with respect to several possible embodiments. Those of skill in the art will appreciate that the invention may be practiced in other embodiments. The particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer and run by a computer processor. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

What is claimed is:

1. A computer-implemented method of activating an on-board warning in a vehicle, comprising:
automatically determining a location of the vehicle;
obtaining, from a facility remotely located from the vehicle, data relating to environmental road conditions proximate to the vehicle, responsive to said automatically determining the location of the vehicle; and
activating the on-board warning responsive to the data.

2. The method of claim 1, wherein the warning relates to dangerous roadway conditions and the data includes at least one type of data from the group consisting of: historical weather data, forecast weather data, data regarding other vehicles obtained from the other vehicles, data regarding roadway clearing operations, and data from roadside sensors.

3. A computer-implemented method for routing a vehicle, the method comprising:
establishing a starting location and a destination for the vehicle;
automatically determining a set of possible routes responsive to the starting location and destination;
automatically determining environmental conditions applicable to the set of possible routes; and
selecting from among the possible routes responsive to the environmental conditions.

4. The method of claim 3, wherein the starting location is a present location of the vehicle and is established using GPS data.

5. The method of claim 3, wherein determining environmental conditions further comprises using historical weather data to predict a state of weather at a time when the vehicle will be in a particular location.

6. The method of claim 3, wherein determining environmental conditions further comprises using forecast weather data to predict a state of weather at a time when the vehicle will be in a particular location.

7. The method of claim 3, wherein determining environmental conditions further comprises collecting data from sensors proximate to locations along the possible routes.

8. The method of claim 3, wherein the sensors are on-board sensors of other vehicles.

9. A user device for controlling an indicator of a vehicle, comprising:
a positioning subsystem configured to establish a location of the vehicle;
a communications subsystem configured to communicate with a remote facility;
and a vehicle interface module configured to activate the indicator responsive to data from the remote facility.

10. The user device of claim 9, wherein the vehicle interface module is further configured to activate the indicator responsive to both the data from the remote facility and data from an on-board sensor of the vehicle.

11. The user device of claim 9, wherein the user device is a smartphone, the positioning subsystem includes a GPS receiver and wherein the communications subsystem is further configured to communicate with the remote facility using the internet.

12. The user device of claim 9, wherein the remote facility is a weather facility.

13. The user device of claim 9, wherein the data from the remote facility includes at least one type of data from the group consisting of: historical weather data, forecast weather data, data regarding other vehicles obtained from the other vehicles, data regarding roadway clearing operations, and data from roadside sensors.

14. The system of claim 9, wherein the data are derived from automatic analysis of travel paths of other vehicles to determine whether such vehicles are experiencing roadway slipping.

15. The system of claim 9, wherein the data are derived from on-board automatic braking system sensors of other vehicles.

16. The system of claim 9, wherein the data are derived from on-board temperature sensors of other vehicles.

17. The system of claim 9, wherein the data are derived from on-board precipitation sensors of other vehicles.

18. The system of claim 9, wherein the data relate to wind conditions proximate to the vehicle.

19. The system of claim 9, wherein the data relate to roadway chain controls.

20. The system of claim 9, wherein the data relate to visibility.
